(19) United States
(12) Patent Application Publication
(10) Pub. No.: US 2026/0025667 A1
(43) Pub. Date: Jan. 22, 2026

(54) BLOCKCHAIN GLOBAL POSITIONING SYSTEM (GPS) DEVICES AND METHODS THEREFOR

(71) Applicant: Michael Hanson, Everett, WA (US)

(72) Inventor: Michael Hanson, Everett, WA (US)

(21) Appl. No.: 19/272,485

(22) Filed: Jul. 17, 2025

Related U.S. Application Data
(60) Provisional application No. 63/672,499, filed on Jul. 17, 2024.

(51) Int. Cl. H04W 12/63; H04L 9/00; H04W 4/029

(52) U.S. Cl. CPC H04W 12/63; H04L 9/50; H04W 4/029

(57) ABSTRACT

Blockchain global positioning system (GPS) devices and methods are provided. A blockchain GPS device includes: a GPS module configured to receive a GPS signal to determine a location of the device, a blockchain interface module configured to facilitate communication between the GPS module and at least one blockchain network, a transaction trigger module configured to initiate a transaction based on a trigger condition, a security protocol module configured to provide secure communication between the GPS module and the at least one blockchain network, and an integration module configured to provide communication integration for the device with the GPS module and the at least one blockchain network.

### CROSS-REFERENCE TO RELATED APPLICATION(S)

This application claims priority to and the benefit of U.S. Provisional Patent Application No. 63/672,499, filed on Jul. 17, 2024, the entire disclosure of which is incorporated herein by reference for all purposes.

### TECHNICAL FIELD

This disclosure generally relates to a blockchain global positioning system (GPS) devices and methods therefore. More particularly, this disclosure relates to integration of GPS functionality with blockchain networks to facilitate decentralized and immutable location tracking and transaction execution.

### BACKGROUND

Existing global positioning system (GPS) units provide accurate location data, but lack the capability to interact with blockchain networks for secure transaction recording and execution. Conversely, blockchain technology offers a decentralized and tamper-proof platform for recording transactions, but requires external sources to provide real-world data, such as location information. Thus, there is a need for integration of GPS functionality with blockchain networks to facilitate decentralized and immutable location tracking and transaction execution.

### SUMMARY

This disclosure pertains location-based services and blockchain technology. For example, it addresses the integration of GPS functionality with blockchain networks to facilitate decentralized and immutable location tracking and transaction execution.

A first aspect of this disclosure pertains to a blockchain global positioning system (GPS) device, including: a GPS module configured to receive a GPS signal to determine a location of the device, a blockchain interface module configured to facilitate communication between the GPS module and at least one blockchain network, a transaction trigger module configured to initiate a transaction based on a trigger condition, a security protocol module configured to provide secure communication between the GPS module and the at least one blockchain network, and an integration module configured to provide communication integration for the device with the GPS module and the at least one blockchain network.

A second aspect of this disclosure pertains to a method for operating a blockchain global positioning system (GPS) device, the method including: acquiring, via a GPS module, location data corresponding to a current location of the device, and interfacing, using a blockchain interface module, with a blockchain network to record the location data onto a blockchain, determining, based on the location data, whether a trigger condition has been satisfied, and when the trigger condition has been satisfied: executing a transaction, and recording the transaction on the blockchain.

A third aspect of this disclosure pertains to a method for a blockchain global positioning system (GPS) device, the method including: providing a GPS module for receiving a GPS signal to determine a location of the device, providing a blockchain interface module for facilitating communication between the GPS module and at least one blockchain network, providing a transaction trigger module for initiating a transaction based on a trigger condition, providing a security protocol module for secure communication between the GPS module and the at least one blockchain network, and providing an integration module for communication integration for the device with the GPS module and the at least one blockchain network.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a block diagram of a blockchain GPS device in accordance with an example embodiment of the present disclosure.

FIG. 2 is a flowchart of a method of operating a blockchain GPS device in accordance with an example embodiment of the present application.

FIG. 3 is a flow diagram for a workflow according to an example embodiment of the present disclosure.

FIG. 4 illustrates certain components that may be included within a computer system according to an example embodiment of the present disclosure.

Before explaining the disclosed embodiments of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Embodiments of the present disclosure merge global positioning system (GPS) technology with blockchain functionality to create a versatile device capable of recording location data onto any blockchain network and initiating transactions and value transfers. Example embodiments may enable seamless integration with diverse blockchain platforms, ensuring compatibility and interoperability across different networks.

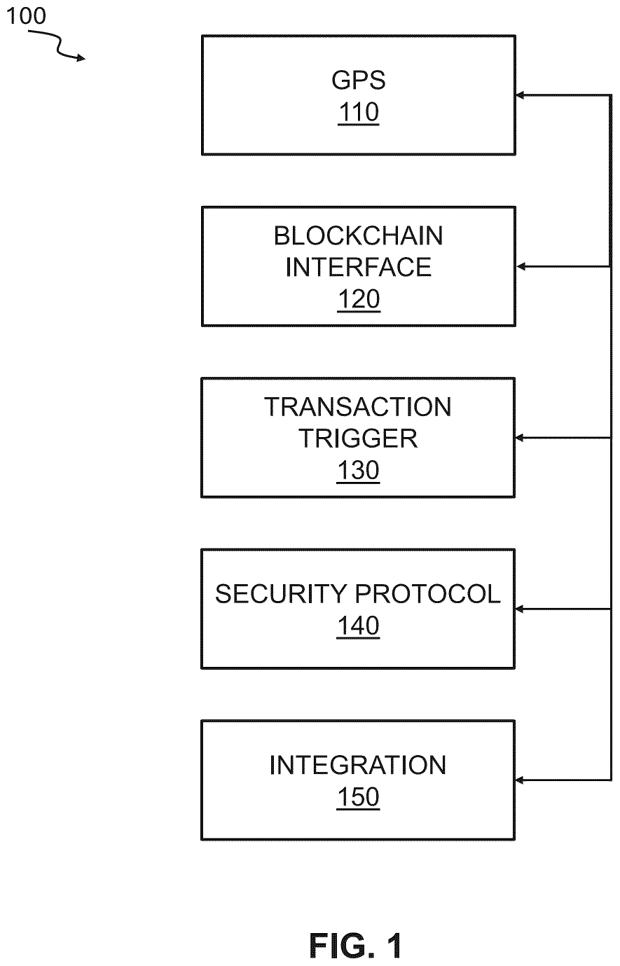

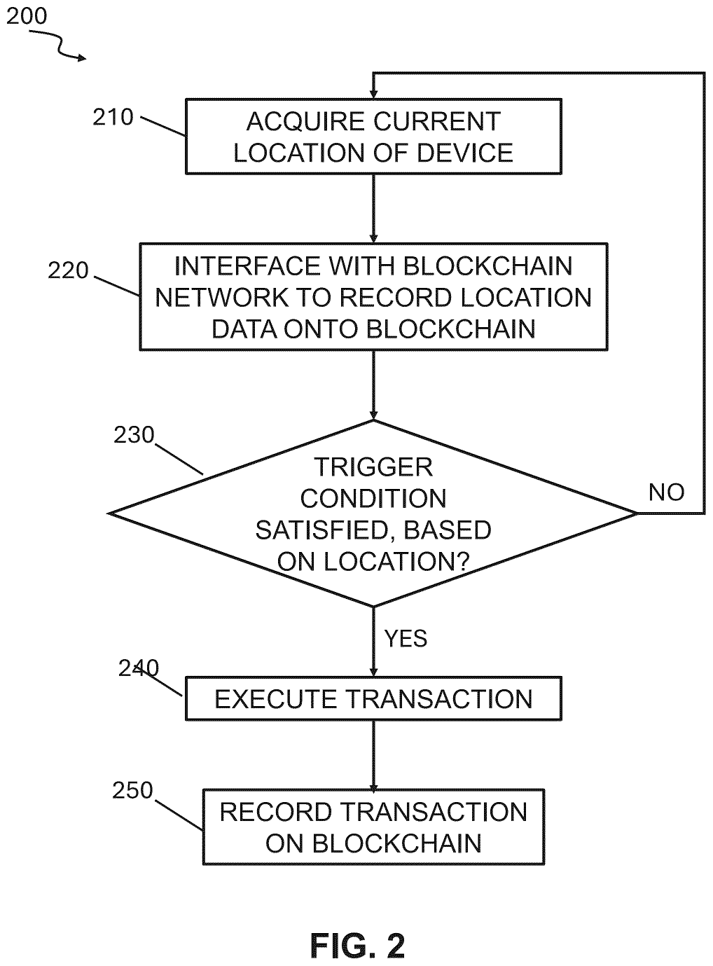

FIG. 1 is a block diagram of a blockchain GPS device in accordance with an example embodiment of the present disclosure. FIG. 2 is a flowchart of a method of operating a blockchain GPS device in accordance with an example embodiment of the present application.

With reference to FIG. 1, a blockchain GPS device 100, which may also be referred to as a “universal” blockchain GPS device, may include a GPS module 110, a blockchain interface module 120, a transaction trigger module 130, a security protocol module 140, and an integration module 150. Each of the GPS module 110, the blockchain interface module 120, the transaction trigger module 130, the security protocol module 140, and the integration module 150 may be implemented using one or more processors, integrated circuits (ICs), field programmable gate arrays (FPGAs), application-specific integrated circuits (ASICs), or other programmable logic, or any other appropriate electronic circuitry capable of performing the functions specified herein.

The GPS module 110 may incorporate satellite-based positioning technology to accurately determine the device's geographical coordinates. The blockchain interface module 120 may facilitate communication between the GPS module 110 and various blockchain networks. The blockchain interface module 120 may support multiple protocols and standards to ensure compatibility with different blockchain platforms. The transaction trigger module 130 may employ smart contract functionality or other automated processes to initiate transactions and value transfers based on predefined criteria for a trigger condition, such as location updates or proximity to specified geofenced areas. The security protocol module 140 may implement robust encryption and authentication mechanisms to safeguard sensitive data and transactions, ensuring the integrity and confidentiality of information exchanged between the GPS module 110 and blockchain networks.

The integration module 150 may provide application programming interface (API) and/or ORACLE® integration. As such the integration module 150 may enable seamless integration with existing GPS units and external data sources, e.g., through APIs and ORACLE® services, for example, an ORACLE® Integration Cloud. (ORACLE® is a registered trademark of Oracle Corporation.) This may allow for the retrieval and recording of location information from GPS devices onto the blockchain network(s).

As part of ongoing testing and development, a crowd-share initiative involving a moving truck equipped with a blockchain GPS device, e.g., the GPS module 110, in accordance with an embodiment of the present disclosure has been undertaken. The crowd-share program allows multiple users to collectively own and utilize the moving truck for transporting goods. A GPS module, e.g., the GPS module 110, records the truck's location data onto the blockchain, ensuring transparency and accountability throughout the transportation process. Users can monitor the truck's progress in real-time and trigger transactions, such as payments or updates to the delivery schedule, via a blockchain interface module, e.g., the blockchain interface module 120.

A method 200 for operating a blockchain GPS device is described. Upon activation, a blockchain GPS device, e.g., the blockchain GPS device 100, may acquire the device's current location using the integrated GPS module, e.g., the GPS module 110 (operation 210). The blockchain GPS device may then interface with the designated blockchain network, e.g., with the blockchain interface module 120 to record the location data onto the blockchain in operation 220. In operation 230, the blockchain GPS device may then determine whether a trigger condition has been satisfied, e.g., based on the current location of the device. When it has been determined that a trigger condition has been satisfied (“YES” result in operation 230), the device may execute one or more predefined transactions, e.g., payments or value transfers, if applicable, in operation 240, and record the transaction(s) on the blockchain in operation 250. If no trigger condition is satisfied (“NO” result in operation 230), the method 200 may restart, e.g., operation 210 of acquiring the current location of the device may be repeated. The blockchain GPS device may continuously update its location, and may repeat the method 200 as necessary, ensuring real-time tracking and transaction execution. Some nonlimiting examples of trigger conditions include a distance traveled, a speed of travel, an amount of time traveled, a location of the device, and/or a position of the device within an area.

As such, embodiments of the present disclosure provide the integration of GPS technology with blockchain functionality for decentralized location tracking and transaction execution.

The blockchain GPS device (or universal blockchain GPS device), in accordance with embodiments of the present disclosure, represents a significant advancement in the fields of location-based services and blockchain technology. By combining the accuracy of GPS technology with the security and decentralization of blockchain networks, the invention offers a versatile solution for secure and tamper-resistant location tracking and transaction execution.

Some nonlimiting examples of use cases of a blockchain GPS device in accordance with embodiments of the present disclosure are provided. For example, GPS may be used to tokenize any and all vehicles of all types including air and watercraft. A blockchain GPS may be used to crowdfund, buy, sell, lease, share, or rent any and all types of vehicles, both motorized and unmotorized. For example, a moving truck, a cargo vehicle, a rideshare vehicle, a rideshare scooter or bicycle, a delivery service vehicle, or the like may be tokenized such that payments are automatically made to an appropriate party based on the recorded GPS location. Blockchain GPS can be used by taxis and ride share companies and drivers utilizing smart contracts. A blockchain GPS may be used to crowdfund, buy, sell, lease, share, or rent use of a person or animal in any use requiring GPS-trackable movement thereof, for example, participation in a marathon or fundraising event.

A driver (or user) may be automatically and immediately paid based on distance traveled, for example, on a periodic basis (e.g., every ‘X’ minutes/hours/days, etc.) or based on reaching a target mileage (e.g., every ‘Y’ miles or after ‘Z’ miles have been driven), or reaching a or geographic location of the vehicle. Alternatively, one or more owners of the vehicle or interest holders may be paid automatically based on any of the above triggering actions. As another example, a geofence may be employed, such that payments are based on going at least a certain distance from a particular point or area, or payment amounts may change based on the location of the vehicle, e.g., based on fuel costs in a particular area or risk assessments of a particular area. The payments can be tied to any information that a GPS unit typically logs. The payments may be on-demand transactions, and can be set to send or collect money (or other value). In some cases, a stakeholder may own a token, and payments may be made, e.g., per mile, on the token, for example, to a driver or user. In some cases, a driver or user may buy back the token.

Blockchain based GPS can be used to make any and all payments, including, but not limited to, insurance companies, token holders, payments to governments, e.g., taxes, tolls, and tabs, charging stations, and fuel pumps. Vehicle dealers and financiers can use the blockchain GPS to collect car payments, for example, on a per-use basis setting. An insurance company may change the amount owed based on the distance traveled during a billing cycle or an average speed within a geographical area. The blockchain can also record any changes to the contracts or bids over time. For example, if a higher bidder is allowed to contract to make payments, then that may be recorded in the blockchain and the new higher bidder would be responsible for the payments.

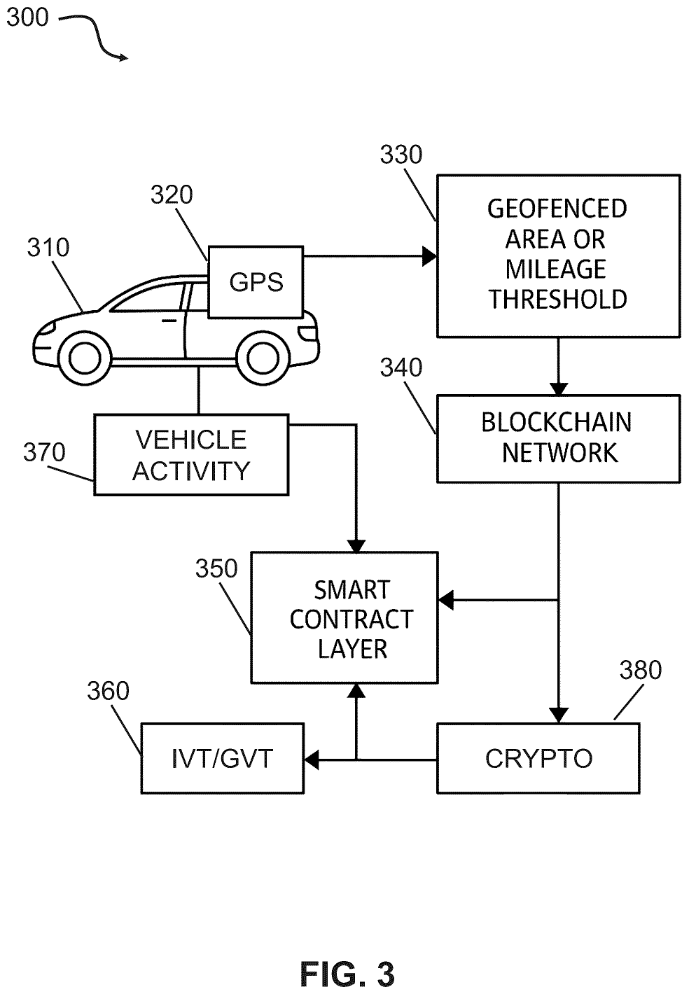

FIG. 3 is a flow diagram for a workflow according to an example embodiment of the present disclosure.

FIG. 3 depicts a workflow 300 for operation of a GPS-triggered blockchain tokenization system. In the example workflow 300, a vehicle 310 is equipped with GPS hardware 320, which may be a GPS module, e.g., the GPS module 110 of FIG. 1. At block 330, the GPS hardware 320 detects either that a mileage threshold has been reached or that the vehicle has entered into a geofenced area. This event triggers a signal to a blockchain network at block 340. Next, a smart contract layer 350 receives the input and performs a blockchain-based transaction. At block 360, the smart contract layer 350 may update or mint at least one of: a (1) Vehicle-Specific Token (IVT) reflecting individual vehicle activity 370, or (2) a Global Vehicle Token (GVT) representing aggregate ecosystem activity. The smart contract layer 350 can also trigger a token exchange with a cryptocurrency 380 (“crypto”). For example, the cryptocurrency 380 may be a stablecoin, which may be tied to a stable (or traditional) currency, e.g., the U.S. dollar, or the cryptocurrency 380 may be any type agreed-to by the parties involved in the transaction, such as Bitcoin, ETHEREUM®, etc. Example embodiments are not necessarily limited to any particular cryptocurrency. The example architecture of the workflow 300 enables automated, hardware-triggered smart contract execution without user intervention.

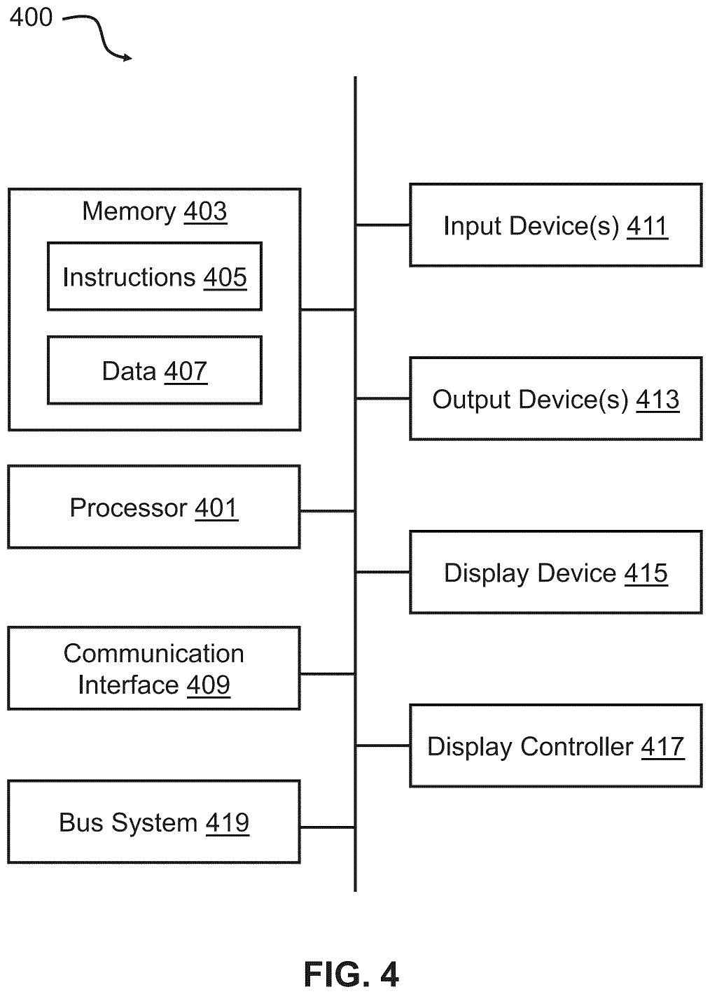

FIG. 4 illustrates certain components that may be included within a computer system according to an example embodiment of the present disclosure.

FIG. 4 illustrates certain components that may be included within a computer system 400, which may be used to control features according to embodiments of the present disclosure, such as the features discussed with reference to FIGS. 1-3. One or more computer systems 400 may be used to implement the various devices, components, and systems described herein.

The computer system 400 includes a processor 401. The processor 401 may be a single processor or may include multiple processors and/or sub-processors. The processor 401 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used. In one or more embodiments, the computer system 400 further includes one or more graphics processing units (GPUs), which can provide processing services related to both entity classification and graph generation.

The computer system 400 also includes memory 403 in electronic communication with the processor 401. The memory 403 may be any electronic component capable of storing electronic information. For example, the memory 403 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory devices or multiple memory devices.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into text, graphics, and/or moving images (as appropriate) shown on the display device 415.

The various components of the computer system 400 may be coupled together by one or more buses, which may include a power bus, a control signal bus, a status signal bus, a data bus, etc. For the sake of clarity, the various buses are illustrated in FIG. 4 as a bus system 419.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A blockchain global positioning system (GPS) device, comprising:
a GPS module configured to receive a GPS signal to determine a location of the device;
a blockchain interface module configured to facilitate communication between the GPS module and at least one blockchain network;
a transaction trigger module configured to initiate a transaction based on a trigger condition;
a security protocol module configured to provide secure communication between the GPS module and the at least one blockchain network; and
an integration module configured to provide communication integration for the device with the GPS module and the at least one blockchain network.

2. A method for operating a blockchain global positioning system (GPS) device, the method comprising:
acquiring, via a GPS module, location data corresponding to a current location of the device; and
interfacing, using a blockchain interface module, with a blockchain network to record the location data onto a blockchain;
determining, based on the location data, whether a trigger condition has been satisfied; and
when the trigger condition has been satisfied:
executing a transaction; and
recording the transaction on the blockchain.

3. A method for a blockchain global positioning system (GPS) device, the method comprising:
providing a GPS module for receiving a GPS signal to determine a location of the device;
providing a blockchain interface module for facilitating communication between the GPS module and at least one blockchain network;
providing a transaction trigger module for initiating a transaction based on a trigger condition;
providing a security protocol module for secure communication between the GPS module and the at least one blockchain network; and
providing an integration module for communication integration for the device with the GPS module and the at least one blockchain network.
